(19) United States
(12) Patent Application Publication
(10) Pub. No.: US 2002/0165730 A1
(43) Pub. Date: Nov. 7, 2002

(54) Intellectual property right management system

(76) Inventor: Masao Matsuda, Tokyo (JP)

Correspondence Address: YOUNG & THOMPSON, 745 SOUTH 23RD STREET 2ND FLOOR, ARLINGTON, VA, 22202

(21) Appl. No.: 09/980,097

(22) PCT Filed: Mar. 28, 2001
(86) PCT No.: PCT/JP01/02594

(30) Foreign Application Priority Data
Mar. 29, 2000 (JP) 2000-092225

(51) Int. Cl. G06F 17/60

(52) U.S. Cl. 705/1

(57) ABSTRACT

An intellectual property right management system collectively executes registration, watching, and use permission of intellectual property rights through a telecommunication circuit, and is constituted by an intellectual property right registration system in which an intellectual property right owner registers an intellectual property right, an intellectual property open investigation system which brings openable intellectual property data into a state in which the data can be perused and searched, and records a use state of intellectual property, and an intellectual property permission watching system including a transaction offer processing unit of intellectual property and a collecting unit of unauthorized permission use information.

### TECHNICAL FIELD

The present invention relates to an intellectual property right management system for executing registration, watching, and use permission of intellectual property rights through a telecommunication circuit.

### BACKGROUND OF THE INVENTION

In intellectual property rights, with respect to industrial property such as a patent right, the right is registered in the register of patents or the like of the Patent Office, and search and reference are made easy through the public information of the application, a patent gazette, and the like.

However, when a copyright as the same intellectual property right is considered as an example, although there is a registration system, the registration of a literary work is not the condition of occurrence of a right, but the occurrence of the copyright originates from the creation of the literary work. However, collective management of the copyright through a database has not been generally executed, and although assignment or buying and selling transaction of the copyright increases year by year, most of the right management is left to the self-effort of the owner of the right. In order to activate the business-based circulation over all areas of the intellectual property rights including the copyright, it is necessary to construct a commercial database of intellectual property rights and to open it to the public. In order to quickly construct the database of various intellectual property rights and to open it to the public, it is necessary for the owners themselves of the rights to use an online registration and publication processing system such as the Internet.

By the way, there is a case where a literary work becomes, if viewed from a different angle, an object of patent or design registration as an invention or creation of a design. Further, a commercialization right to raise an additional value of another commodity arises from singularity of a created thing. Besides, with the remarkable development of recent biotechnology, there occurs many seed and seedling rights of new forms in which patterns of flowers, shapes and the like can be shaped as designed. In addition, the existence of trademark rights in which characters, figures, and solids as names of services are objects of the trademarks is also important in the market, and these are main beings of the intellectual property rights. That is, several kinds of intellectual property rights occur for one created thing at the same time and the collective management of those becomes indispensable.

In order to suitably use the intellectual property rights, a watching system over a wide range and a collective management system are necessary. Even if an intellectual property right occurs, if it is infringed, the right actually becomes valueless. Besides, with the remarkable advance of technology in recent years, the infringement of the intellectual property right is made more easily and in a wide range, and it is impossible to watch the infringement by only the owner of the right. Then, the watching system over a wide range is desired, and the collective management system is required also for removing the oversight of watching.

Accordingly, an object of the present invention is to provide an intellectual property right management system in which intellectual property rights are opened to the public and are made to be contained in a database while human processing is reduced to a minimum, and registration, watching, and use permission of the intellectual property rights can be collectively executed through a telecommunication circuit.

### DISCLOSURE OF THE INVENTION

In order to solve the problem, an intellectual property right management system of the present invention is made of an intellectual property right management system for collectively executing registration, watching, and use permission of intellectual property rights through a telecommunication circuit, and is characterized by comprising an intellectual property registration system in which an intellectual property right owner registers an intellectual property right, an intellectual property open investigation system which brings openable intellectual property data into a state in which the data can be perused and searched, and records a use state of intellectual property, and an intellectual property permission watching system including transaction offer processing means of intellectual property and collecting means of unauthorized permission use information.

The intellectual property registration system comprises a multimedia terminal by which the intellectual property right owner can execute a registration operation, an operator terminal by which a registration operation full-time person executes a registration operation, a terminal communication network for connecting the terminals and a multimedia registration processing system, the multimedia registration processing system, and an intellectual property management database.

The multimedia registration processing system comprises a multimedia switching server capable of connecting with any terminal of an image processing terminal, a multimedia terminal, and a voice terminal through the terminal communication network, and a multimedia communication network capable of connecting with the intellectual property management database.

The intellectual property management database comprises an author database, a database comprised of sentences and poems, a database comprised of photographs, moving pictures, and still pictures, a database comprised of comics and illustrations, a sound database, an idea commodity database, a patent right database, a utility model right database, a design right database, a trademark right database, a seed and seedling right database, a commercialization right database, an introducer database, and a COOKY database.

The intellectual property open investigation system comprises a use permission database, an intellectual property basic system, a use state investigation system, an open intellectual property database, an intellectual property use report database, a multimedia registration processing system, a terminal communication network, an image processing terminal, a multimedia terminal, and a voice terminal.

The intellectual property permission watching system comprises an image processing terminal, a multimedia processing terminal, a voice terminal, a terminal communication network, a multimedia registration processing system, an intellectual property use state report processing system, a use offer database, a permission confirmation inability database, and an intellectual property permission management system.

Further, the present invention provides an intellectual property right management method for executing registration, watching and use permission of intellectual property rights through a telecommunication circuit, and is characterized by comprising an intellectual property registration method in which an intellectual property right owner registers an intellectual property right, an intellectual property open investigation method which brings openable intellectual property data into a state in which the data can be perused and searched, and records a use state of intellectual property, and an intellectual property permission watching method including a transaction offer processing step of intellectual property and a collecting step of unauthorized permission use information.

The intellectual property registration method comprises a step in which the intellectual property right owner executes a registration operation of the intellectual property right by a multimedia terminal, a step in which a registration operation full-time person executes a registration operation by an operator terminal, a step of connecting the terminals and a multimedia registration processing system through a terminal communication network, and a step in which the multimedia registration processing system registers data transmitted from the terminals in an intellectual property management database.

The intellectual property registration method comprises a step in which a person to be introduced is introduced to one of an intellectual property right person, an intellectual property right user, and an intellectual property right watcher, a step in which the introduced person is given a tentative address after introduction and is registered in an introducer database, a step in which when the introduced person uses the tentative address after registration to actually access, a honorarium or a prize is supplied to an introducer, and a step in which the introduced person acquires a normal address.

This intellectual property registration method comprises a step in which when one of the intellectual property right owner, the intellectual property right user and the intellectual property right watcher accesses the multimedia registration processing system, the multimedia registration processing system attaches COOKY to the one of the intellectual property right owner, the intellectual property right user, and the intellectual property right watcher, and a step in which when the one of the intellectual property right owner, the intellectual property right user, and the intellectual property right watcher again accesses, authentication is executed by using the COOKY.

This intellectual property right open investigation method comprises a step of copying the openable intellectual property in an open literary work database from an intellectual property management database and a use permission database, a step in which the intellectual property right user accesses an open intellectual property database through the terminal communication network and the multimedia registration processing system, a step in which the intellectual property right user searches intellectual property rights from the open intellectual property database, a step in which the intellectual property right user searches by a search processing system connected to the terminal communication network, a step in which the intellectual property right watcher registers a use state of an intellectual property right in an intellectual property use report database, and a step of reporting data of the use permission database and data of the intellectual property use report database to an intellectual property use state report processing system.

The intellectual property permission watching method comprises a step in which a person who wants to use an intellectual property right applies to the intellectual property use state report processing system for use of an intellectual property right through the terminal communication network and the multimedia registration processing system from an image processing terminal, a multimedia processing terminal and a voice terminal, a step in which the intellectual property use state report processing system registers the person who wants to use the intellectual property right in a use offer database when the use of the intellectual property right is permitted, and a step in which an intellectual property permission management system issues a written permission and a bill of use costs to the person who wants to use the intellectual property right.

The intellectual property permission watching method comprises a step of registering difference data of reports from the data of the intellectual property use report database and the data of the use permission database in a permission confirmation inability database, a step of investigating use permission of the data registered in the permission confirmation inability database, and a step of warning the user, who has been identified as a not-permitted person, to acquire permission and transmitting a name of the user, who is not permitted to use the intellectual property open investigation system, to open it to the public, and

the intellectual property permission management system includes a step of issuing a bill to the user who is not permitted to use.

### BRIEF DESCRIPTION OF THE DRAWINGS

FIG. 1 is an explanatory view showing the constitution of an intellectual property management system of the present invention.

FIG. 2 is an explanatory view showing the constitution of an intellectual property registration system of the present invention.

FIG. 3 is an explanatory view showing the constitution of an intellectual property open investigation system of the present invention.

FIG. 4 is an explanatory view showing the constitution of a multimedia registration processing system of the present invention.

FIG. 5 is an explanatory view showing the constitution of an intellectual property permission watching system of the present invention.

### BEST MODE FOR CARRYING OUT THE INVENTION

Other details, merits, and features of the present invention will be described through embodiments set forth below with reference to the accompanying drawings.

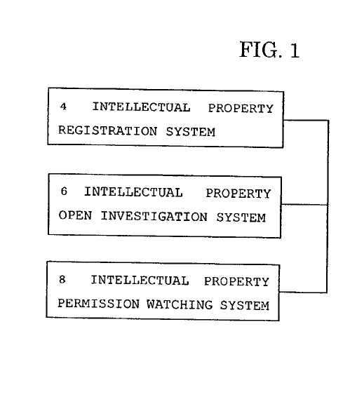

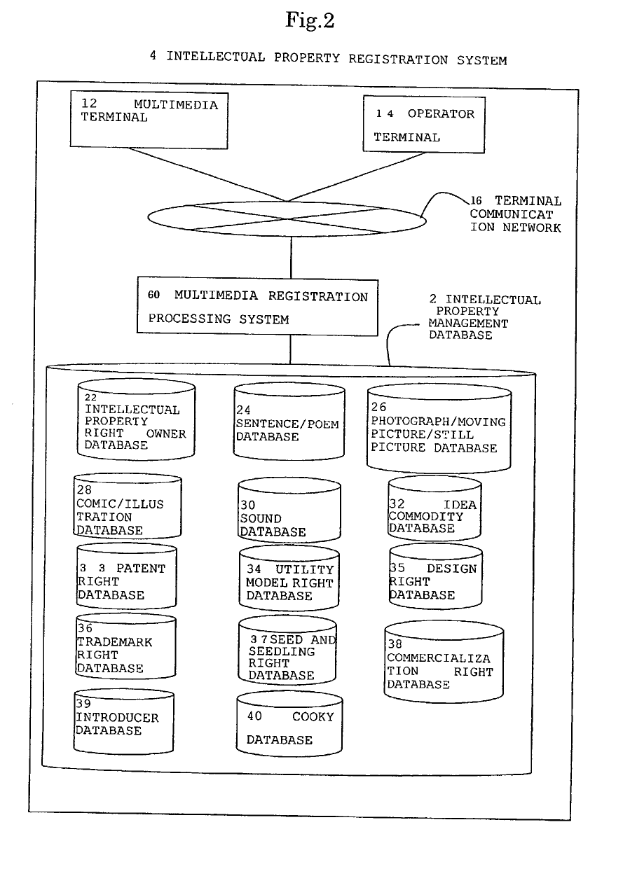

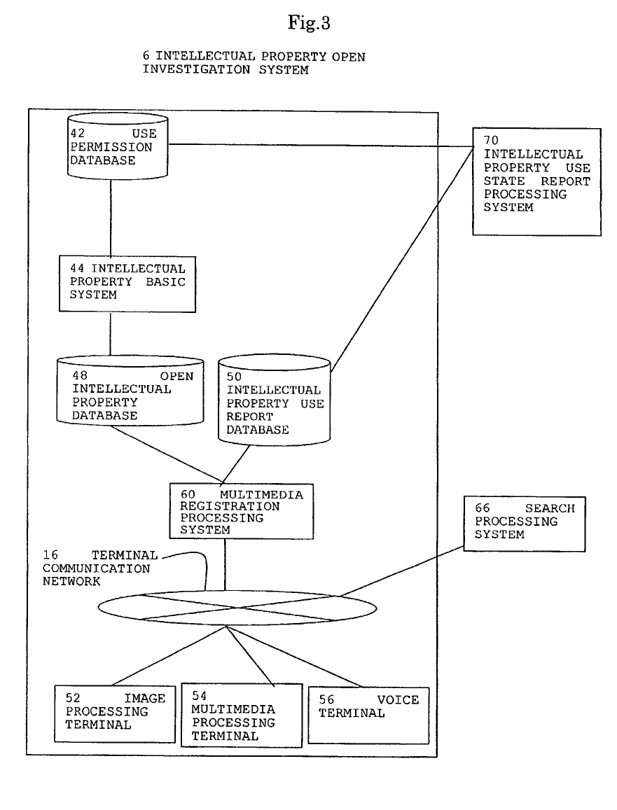

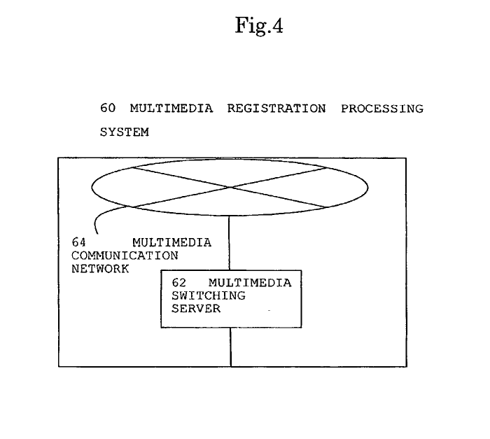

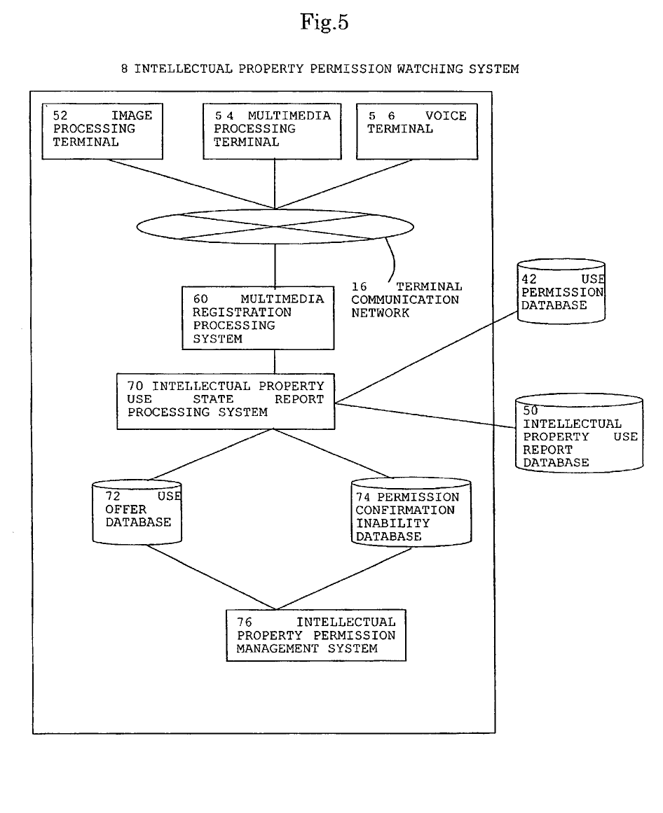

FIG. 1 is an explanatory view showing the constitution of an intellectual property management system of the present invention. FIG. 2 is an explanatory view showing the constitution of an intellectual property registration system of the present invention. FIG. 3 is an explanatory view showing the constitution of an intellectual property open investigation system of the present invention. FIG. 4 is an explanatory view showing the constitution of a multimedia registration processing system of the present invention. FIG. 5 is an explanatory view showing the constitution of an intellectual property permission watching system of the present invention.

Hereinafter, the description will be given in the order of

1) constitution and execution procedure of a system of the present invention,

2) constitution and execution procedure of an intellectual property registration system of the present invention,

3) constitution and execution procedure of an intellectual property open investigation system of the present invention,

4) constitution of a multimedia registration processing system of the present invention, and

5) constitution and execution procedure of an intellectual property permission watching system of the present invention.

1) Constitution and Execution Procedure of a System of the Present Invention

In an intellectual property management system of the present invention, as shown in FIG. 1, an intellectual property registration system 4, an intellectual property open investigation system 6, and an intellectual property permission watching system 8 are electrically connected to one another.

The intellectual property registration system 4 is a system in which an intellectual property right owner registers the intellectual property right. The intellectual property right owner can register from a remote place through a telecommunication circuit by this registration system.

The intellectual property open investigation system 6 brings openable intellectual property data into a state in which it can be perused and searched, and records the use state of intellectual property. With respect to the intellectual property data, the openable data in a database mainly registered by the intellectual property permission watching system can be perused and searched

The intellectual property permission watching system 8 includes transaction offer processing means of intellectual property and collecting means of unauthorized permission use information. It gives use permission to a person who wants to use the registered intellectual property data and issues a bill. Besides, it investigates a not-permitted user, gives an warning, and charges a use fee.

Next, the execution procedure of the intellectual property registration system is such that an intellectual property right registration method, an intellectual property open investigation method, and an intellectual property permission watching method are executed in this order.

The intellectual property right registration method is a procedure in which an intellectual property right owner registers the intellectual property right.

The intellectual property open investigation method is a procedure for enabling the openable intellectual property data to be perused and searched and for recording the use state of the intellectual property.

The intellectual property permission watching method is a procedure for performing the transaction offer processing of the intellectual property and for collecting the unauthorized permission use information.

By the use of the above systems, copyrights are opened to the public and are made to be contained in the database while human processing is reduced to a minimum, and the registration, watching, and use permission of the intellectual property rights can be collectively executed through the telecommunication circuit.

2) Constitution and Execution Procedure of an Intellectual Property Registration System of the Present Invention

In the intellectual property registration system 4, as shown in FIG. 2, an intellectual property management database 2, a multimedia system 60, a terminal communication network 16, a multimedia terminal 12, and an operator terminal 14 are connected through a telecommunication circuit.

The intellectual property management database 2 includes an intellectual property right owner database 22, a sentence/poem database 24, a photograph/moving picture/still picture database 26, a comic/illustration database 28, a sound database 30, an idea commodity database 32 and a patent right database 33, a utility model right database 34, a design right database 35, a trademark right database 36, a seed and seedling right database 37, a commercialization right database 38, an introducer database 39, and a COOKY database 40.

The intellectual property right owner database 22 is a database of intellectual property right owners who registered the intellectual property in the database by using the intellectual property registration system.

The sentence/poem database 24 is a database made of sentences and poems written or dictated in any languages, other books recited in characters or recorded, and electric data, and is formed of what are registered in this database.

The photograph/moving picture/still picture database 26 includes silver salt photographs, the films, still picture data photographed by digital cameras, moving picture data photographed by video cameras, video data photographed by television cameras, photographs, moving pictures, and still pictures photographed by movie cameras and made of films or the like, and is formed of what are registered in this database.

The comic/illustration database 28 includes paintings, comics, animations, illustrations, patterns, colors, and their combinations drawn by painters, comic artists, illustrators and the like, and is formed of what are registered in this database.

The sound database 30 is a database including pieces of music, operas, musical dramas, musicals, folk songs, domestic popular songs, popular songs, karaoke, and sounds used as signs, and is formed of what are registered in this database.

The idea commodity database 32 is a database including specifications, design drawings, outline drawings, and the like of commodities manufactured by using ideas which do not become patents or utility models, and is formed of what are registered in this database.

The patent right database 33 is a database in which patent rights are registered.

The utility mode database 34 is a database in which utility model rights are registered.

The design database 35 is a database in which design rights are registered.

The trademark database 36 is a database in which trademark rights are registered.

The seed and seedling right database 37 is a database in which flowers, vegetables, fruits and other plants are registered.

The commercialization right database 38 is a database in which rights for arranging literary works on commodities to make them commodities, character use rights and the like are registered.

The introducer database 39 is constituted by data for authentication used when a user introduced to an existing intellectual property right owner, searcher, or watcher first accesses after introduction.

The COOKY database 40 is used to identify a user accessing by using the terminal communication network 16. An intrinsic ID is distributed to the user once accessed, and distributes it to a user connection terminal. At the time of re-accessing of the user, authentication at the connection is enabled by the distributed COOKY data.

The above databases are examples, and any database can be included in the intellectual property management database 2 as long as it is intellectual property.

The multimedia system 60 is, although described later, a registration processing system which can receive any data format. Besides, it has an authentication function to a terminal communication network accessing person at the same time.

The terminal communication network 16 may be any communication network of a public telephone network, an internet network, a private line network, and a LAN communication network as long as the communication network can connect the multimedia terminal 12, the operator terminal 14, and the multimedia system 60.

The multimedia terminal 12 is a terminal used when an intellectual property right owner himself registers the intellectual property right. Any device of a personal computer, a word processor, a portable terminal, a portable telephone, and others may be used as long as it has a function of being capable of registering intellectual property right data by connection with the terminal communication network 16.

The operator terminal 14 is a terminal used when a specialized operator in charge of the operation exists and registers an intellectual property right in accordance with a request by an intellectual property right owner. Any device of a personal computer, a word processor, a portable terminal, a portable telephone, and others may be used as long as it has function of being capable of registering intellectual property right data by connection with the terminal communication network 16.

Next, the execution procedure of the intellectual property registration system will be described.

Any one of an intellectual property right owner, an intellectual property right user, and an intellectual property right watcher, as a user of this system, is registered in this system and acquires a formal address. That is, only the owner of the formal address is authenticated and can access this system.

Besides, in order to increase users of this system, an incentive is given to an intellectual property right owner, an intellectual property right user or an intellectual property right watcher who has introduced a new introducer. That is, a person to be introduced is introduced to this system. Subsequently, after introduction, the introduced person is given a tentative address and is registered in the introducer database. Further, when the introduced person uses the tentative address after registration to actually access, a honorarium or a prize is supplied to the introducer. Thereafter, the introduced person acquires the formal address.

Further, the COOKY is used as an authentication method. The COOKY is distributed by the multimedia registration processing system to the accessing intellectual property right owner, intellectual property right user, or intellectual property right watcher. When the intellectual property right owner, the intellectual property right user, or the intellectual property right watcher again accesses, the multimedia registration processing system acquires the COOKY data from the intellectual property right owner, the intellectual property right user, or the intellectual property right watcher and compares it with a past distributor of the same COOKY. By this, the multimedia registration processing system can judge that the same address user accesses through the same terminal.

Next, in the procedure, the intellectual property right owner accesses the multimedia registration processing system 60 from the multimedia terminal 12 through the terminal communication network 16.

Subsequently, the multimedia registration processing system 60 authenticates the intellectual property right owner. As a result of authentication, in the case where the intellectual property right owner is previously registered and is permitted, the registration of the intellectual property right is permitted.

After the permission of the registration, the intellectual property right owner selects a database for the registration from the sentence/poem database 24, the photograph/moving picture/still picture database 26, the comic/illustration database 28, the sound database 30, and the idea commodity database 32. As the contents of the registration, an intellectual property specification key, an intellectual property management number, an intellectual property specification link, a use division code, a use application example, an assignment fee, an assignment fee currency division, a use division, a use fee, a use fee currency division, a use unit, a use unit name, a fee negotiation division, and a right name are registered.

The intellectual property specification key is a first key of this database.

The intellectual property management number is the number of an intellectual property table.

The intellectual property specification link is an internet address or the like of specification information of intellectual property.

The use classification code is a classification code of an industrial classification table of the user.

The use application example is character information of a use example or a usable field.

The assignment fee is a sum in the case where the intellectual property right is assigned.

The assignment fee currency division is a currency division of the assignment fee.

The use division is a use division of exclusive, specific, and arbitrary use and is a use code of a use division table.

The use fee is a use unit amount or the like in the case where the intellectual property right is used.

The use fee currency division is a currency division of the use fee and is a currency code of a currency table.

The use unit is a use unit amount or the like in the case where the intellectual property is used.

The use unit name is a name of the use unit.

The fee negotiation division is a negotiatable content code of assignment and use fee, and is a fee negotiation division table.

The right name is a table which indicates that a subject created thing is one of or a combination of a registered copyright, a patent right, a utility model right, a design right, a trademark right, a seed and seedling right, a commercialization right, and other intellectual property rights.

The above registration may be carried out by the operator through the operator terminal 14 instead of the intellectual property right owner.

3) Constitution and Execution Procedure of an Intellectual Property Open Investigation System of the Present Invention

In the intellectual property open investigation system 6, as shown in FIG. 3, a use permission database 42, an intellectual property basic system 44, an open intellectual property database 48, an intellectual property use report database 50, a multimedia registration processing system 60, a terminal communication network 16, an image processing terminal 52, a multimedia processing terminal 54, and a voice terminal 56 are connected through a telecommunication circuit. Besides, the intellectual property open investigation system 6 is connected to an intellectual property use state report processing system 70 and a search processing system 66.

The use permission database 42 is a database storing data to which use permission is given out of the intellectual property registered by the intellectual property registration system 4. That is, a use not registered in this data is a not-permitted use. The use permission database 42 is also connected with the intellectual property use state report processing system 70, and transmits the data.

The intellectual property basic system 44 is a system having a function of opening the openable intellectual property to the public, out of the intellectual property registered by the intellectual property registration system 4. Besides, it has a function of acquiring unauthorized use information and proper use information from the intellectual property permission watching system 8 and opening it to the public. Further, it has a function of delivering data of the intellectual property right use report database 50 to the intellectual property permission watching system 8.

The open intellectual property database 48 is a database storing the openable intellectual property data out of the intellectual property registered by the intellectual property registration system 4. By opening the open intellectual property database 48 to the public, a person not having a right is enabled to search. The intellectual property right can be searched, and it becomes possible to use or purchase the intellectual property right, and further, it becomes possible to prevent infringement from occurring. Further, even a person not having a right can easily judge whether an unauthorized use is made, and it becomes possible to watch the use of the intellectual property.

In the intellectual property right use report database 50, an intellectual property right watcher registers the use states of intellectual property rights.

The multimedia system 60 is, although described later, a registration processing system which can receive any data format. Besides, it has an authentication function to a terminal communication network accessing person at the same time.

The terminal communication network 16 may be any communication network of a public telephone network, an internet network, a private line network, and a LAN communication network as long as the communication network can connect the image processing terminal 52, the multimedia processing terminal 54, the voice terminal 56 and the multimedia system 60.

The image processing terminal 52 is specifically a FAX and is a terminal used when the open intellectual property database 48 is searched by using the FAX.

The multimedia processing terminal 54 is a terminal used when an intellectual property searcher searches the open intellectual property database 48. Any device of a personal computer, a word processor, a portable terminal, a portable telephone, and others may be used as long as it can be connected to the terminal communication network 16 to search the intellectual property right data.

The voice terminal 56 is specifically a telephone and is a terminal used when the open intellectual property database 48 is searched by using the telephone.

The search processing system 66 is an intellectual property right investigation system other than this system, which is connected to the terminal communication network. Specifically, by connection with the intellectual property right investigation system of the Patent Office, the patent rights, utility model rights, design rights, and trademark rights can be searched.

Next,in the execution procedure of the intellectual property open investigation system 4, the intellectual property basic system 44 acquires the open intellectual property information from the intellectual property registration system 4, and copies it in the open intellectual property database 48.

Subsequently, the intellectual property basic system 44 acquires the proper use information from the intellectual property permission watching system 8 and prepares the use permission database 42.

Further, a general user accesses the multimedia registration processing system 60 from any terminal of the image processing terminal 52, the multimedia processing terminal 54, and the voice terminal 56 through the terminal communication network 16.

Besides, the general user accesses the open intellectual property database access 48 and can search and acquire the assignment condition, use condition, property right owner, and other information of the intellectual property.

Further, it is also possible to search open intellectual property not registered in this system by using the search processing system 66.

On the other hand, when knowing the use of intellectual property, the general user can register the information in the intellectual property use report database 50. By this function, the use watching of the intellectual property by the general person becomes possible.

Further, the intellectual property open investigation system 6 reports data of the use permission database 42 and data of the intellectual property use report database 50 to the intellectual property right use state report processing system 70.

4) Constitution and Execution Procedure of a Multimedia Registration Processing System 60 of the Present Invention

The multimedia registration processing system 60 of the present invention is constituted by, as shown in FIG. 4, a multimedia switching server 62 and a multimedia communication network 64.

One end of the multimedia switching server 62 is connected to the terminal communication network 16 and the other end is connected to the multimedia communication network 64. The multimedia switching server 62 is connected to the image processing terminal 52 such as a FAX, and a search operation using the FAX is enabled. Besides, in the multimedia switching server 62, a search operation is enabled by an automatic response system to a voice terminal such as a telephone and by an operation using voice and push buttons. Besides, at the time of connection to the multimedia processing terminal, the transmission and reception of voices, images, moving images, and the other data is enabled.

The multimedia communication network 64 receives images, music, and the other data received by the multimedia switching server 62, and classifies and transmits them.

5) Constitution and Execution Procedure of an Intellectual Property Permission Watching System of the Present Invention.

In the intellectual property permission watching system 8, as shown in FIG. 5, an intellectual property use state report processing system 70, a use offer database 72, a permission confirmation inability database 74, an intellectual property permission management system 76, a multimedia registration processing system 60, a terminal communication network 16, an image processing terminal 52, a multimedia processing terminal 54, and a voice terminal 56 are connected through a telecommunication circuit.

The intellectual property use state report processing system 70 records the intellectual property offer content of a person who wants to use intellectual property in the use offer database 72. Besides, it receives reports of data of the use permission database 42 and data of the intellectual property use report database 50 and registers their difference information in the permission confirmation inability database 74.

In the use offer database 72, the permission request content of the person who wants to use the intellectual property is recorded.

In the permission confirmation inability database 74, permission confirmation inability information as the difference information of the data of the use permission database 42 and the data of the intellectual property use report database 50 is registered.

The intellectual property permission management system 76 confirms the use offer database 72, and in the case where there is a person who wants to use intellectual property, it negotiates a price and issues a written permission and a bill to the person who wants to use the intellectual property. Besides, it confirms the permission confirmation inability database 74, and in the case where there is, permission confirmation inability information, it investigates the actual situation, and gives a warning of a unauthorized use stop request.

The multimedia system 60 is, although described later, a registration processing system which can receive any data format. Besides, at the same time, it has an authentication function to a terminal communication network accessing person.

The terminal communication network 16 may be any communication network of a public telephone network, an internet network, a private line network, and a LAN communication network as long as the communication network can connect the image processing terminal 52, the multimedia processing terminal 54, the voice terminal 56 and the multimedia system 60.

The image processing terminal 52 is specifically a FAX and is a terminal used when a use offer or watching of permission confirmation inability data is performed by using the FAX.

The multimedia processing terminal 54 is a terminal used when a use offer or watching of permission confirmation inability data is performed. Any device of a personal computer, a word processor, a portable terminal, a portable telephone, and the others may be used as long as it can be connected to the terminal communication network 16 to perform the use offer or the watching of the permission confirmation inability data.

The voice terminal 56 is specifically a telephone and is a terminal used when a use offer or watching of permission confirmation inability data is performed by using a telephone.

Next, in the execution procedure of the intellectual property permission watching system 8, there are two procedures of a use offer procedure and a watching procedure.

The use offer procedure is started from a step in which a person who wants to use intellectual property accesses the multimedia registration processing system 60 from any one of the image processing terminal 52, the multimedia processing terminal 54, and the voice terminal 56.

After the multimedia registration processing system 60 authenticates the person who wants to use the intellectual property, the person who want to use the intellectual property makes an intellectual property use permission offer to the intellectual property use state report processing system 70. That is, the contents of the intellectual property use permission offer are a case name of an intellectual property right the use of which is desired, a use period, an exclusive use or a normal use, a use expense, a user name, a residence or an address of the user, a base name used, and the other information necessary for the use.

The intellectual property use state report processing system 70 registers the contents of the intellectual property use permission offer in the use offer database 72.

The intellectual property permission management system 76 issues a written permission and a bill to the person who wants to use the intellectual property on the basis of the use offer database 72.

Further, the watching procedure is started from a step in which an intellectual property use watcher accesses the multimedia registration processing system 60 from any one of the image processing terminal 52, the multimedia processing terminal 54, and the voice terminal 56.

After the multimedia registration processing system 60 authenticates the intellectual property use watcher, the intellectual property use watcher reports the use states of intellectual property rights to the intellectual property use state report processing system 70. The use state is composed of a kind of an intellectual property right used, a user name, a use place, a use time, a use object, a use method, and other information to clarify the use, such as a name of a proof.

The intellectual property use state report processing system 70 records the use state of the intellectual property right in the intellectual property use report database 50.

The intellectual property use state report processing system 70 records the difference information between the data of the use permission database 42 and the data of the intellectual property use report database 50 in the permission confirmation inability database 74. That is, the difference information is information composed of presence or absence of use permission, inconsistency of use time, inconsistency of use place, inconsistency of user name, inconsistency of use object, inconsistency of use intellectual property right, inconsistency of use method, and other difference from registered contents.

The intellectual property permission management system 76 investigates the actual situation on the basis of the permission confirmation inability database 74. That is, it specifically investigates the fact of the use of the intellectual property right, together with a point differing from the contents of a contract at the time of permission. This investigation is performed by this system in the case where it can be electrically performed by the search on the Internet. Further, in the case where it turned out to be wicked, a warning to stop the unauthorized use of the intellectual property is given.

From the above, it becomes possible to execute the registration, watching, and use permission of the intellectual property right through the telecommunication circuit.

By carrying out the intellectual property right management system of the present invention, the intellectual property rights are made to be contained in the database and are opened to the public while human processing is reduced to a minimum, and it becomes possible to collectively perform the registration, watching, and use permission of the intellectual property rights through the telecommunication circuit.

Although the basic constitution of the present invention and the typical embodiments have been described, it is to be understood that various design modifications can be made for one of ordinary skill in the art without departing the scope and the gist of the present invention.

1. An intellectual property right management system for collectively executing registration, watching, and use permission of intellectual property rights through a telecommunication circuit, wherein the intellectual property right management system comprises an intellectual property registration system in which an intellectual property right owner registers an intellectual property right, an intellectual property open investigation system which enables openable intellectual property data to be perused and searched, and records a use state of intellectual property, and an intellectual property permission watching system including transaction offer processing means of intellectual property and collecting means of unauthorized permission use information.

2. An intellectual property right management system according to claim 1, characterized in that the intellectual property registration system comprises a multimedia terminal by which the intellectual property right owner can execute a registration operation, an operator terminal by which a registration operation full-time person executes a registration operation, a terminal communication network for connecting the terminals and a multimedia registration processing system, the multimedia registration processing system, and an intellectual property management database.

3. An intellectual property right management system according to claim 2, characterized in that the multimedia registration processing system comprises a multimedia switching server capable of connecting with any terminal of an image processing terminal, a multimedia terminal, and a voice terminal through the terminal communication network after authentication, and a multimedia communication network capable of connecting with the intellectual property management database.

4. An intellectual property right management system according to any one of claims 1 to 3, characterized in that the intellectual property management database comprises an intellectual property right owner database, a database comprised of sentences and poems, a database comprised of photographs, moving pictures, and still pictures, a database comprised of comics and illustrations, a sound database, an idea commodity database, a patent right database, a utility model right database, a design right database, a trademark right database, a seed and seedling right database, a commercialization right database, an introducer database, and a COOKY database.

5. An intellectual property right management system according to any one of claims 1 to 4, characterized in that the intellectual property open investigation system comprises a use permission database, an intellectual property basic system, a use state investigation system, an open intellectual property database, an intellectual property use report database, a multimedia registration processing system, a terminal communication network, an image processing terminal, a multimedia terminal, and a voice terminal.

6. An intellectual property right management system according to any one of claims 1 to 5, characterized in that the intellectual property permission watching system comprises an image processing terminal, a multimedia processing terminal, a voice terminal, a terminal communication network, a multimedia registration processing system, an intellectual property use state report processing system, a use offer database, a permission confirmation inability database, and an intellectual property permission management system.

7. An intellectual property right management method for executing registration, watching and use permission of intellectual property rights through a telecommunication circuit, wherein the intellectual property right management method comprises an intellectual property right registration method in which an intellectual property right owner registers an intellectual property right, an intellectual property open investigation method which enables openable intellectual property data to be perused and searched, and records a use state of intellectual property, and an intellectual property permission watching method including a transaction offer processing step of intellectual property and a collecting step of unauthorized permission use information.

8. An intellectual property right management method according to claim 7, characterized in that the intellectual property registration method comprises a step in which a person to be introduced is introduced to one of an intellectual property right owner, an intellectual property right user, and an intellectual property right watcher, a step in which the introduced person is given a tentative address after introduction and is registered in an introducer database, a step in which when the introduced person uses the tentative address after registration to actually access, a honorarium or a prize is supplied to an introducer, and a step in which the introduced person acquires a normal address.

9. An intellectual property right management method according to claim 8, characterized in that the intellectual property registration method comprises a step in which when one of the intellectual property right owner, the intellectual property right user, and the intellectual property right watcher accesses a multimedia registration system, the multimedia registration processing system attaches COOKY to the one of the intellectual property right owner, the intellectual property right user, and the intellectual property right watcher, and a step in which when the one of the intellectual property right owner, the intellectual property right user, and the intellectual property right watcher again accesses, authentication is executed by using the COOKY.

10. An intellectual property right management method according to any one of claims 7 to 9, characterized in that the intellectual property registration method comprises a step in which the intellectual property right owner executes a registration operation of the intellectual property right by a multimedia terminal, a step in which a registration operation full-time person executes a registration operation by an operator terminal, a step of connecting the terminals and a multimedia registration processing system through a terminal communication network after authentication, and a step in which the multimedia registration processing system registers data transmitted from the terminals in an intellectual property management database.

11. An intellectual property right management method according to any one of claims 7 to 10, characterized in that the intellectual property right open investigation method comprises a step of copying openable intellectual property in an open literary work database from an intellectual property management database and a use permission database, a step in which an intellectual property right user accesses the open intellectual property database through a terminal communication network and a multimedia registration processing system, a step in which the intellectual property right user searches the intellectual property rights from the open intellectual property database, a step in which the intellectual property right user searches by a search processing system connected to the terminal communication network, a step in which an intellectual property right watcher registers a use state of an intellectual property right in an intellectual property use report database, and a step of reporting data of the use permission database and data of the intellectual property use report database to an intellectual property use state report processing system.

12. An intellectual property right management method according to any one of claims 7 to 11, characterized in that the intellectual property permission watching method comprises a step in which a person who wants to use an intellectual property right applies to an intellectual property use state report processing system for use of an intellectual property right through a terminal communication network and a multimedia registration processing system from an image processing terminal, a multimedia processing terminal and a voice terminal, a step in which the intellectual property use state report processing system registers the person who wants to use the intellectual property right in a use offer database when the use of the intellectual property right is permitted, and a step in which an intellectual property permission management system issues a written permission and a bill of use costs to the person who wants to use the intellectual property right.

13. An intellectual property right management method according to any one of claims 7 to 12, characterized in that the intellectual property permission watching method comprises a step of registering difference data of reports from the data of the intellectual property use report database and the data of the use permission database in a permission confirmation inability database, a step of investigating use permission of the data registered in the permission confirmation inability database, a step of warning a user, who has been identified as a not-permitted person, to acquire permission and transmitting a name of the user, who is not permitted to use the intellectual property open investigation system, to open it to the public, and a step in which the intellectual property permission management system issues a bill to the user who is not permitted to use.
